(19) United States
(12) Patent Application Publication
(10) Pub. No.: US 2020/0023592 A1
(43) Pub. Date: Jan. 23, 2020

(54) METHOD FOR CONNECTING THREE COMPONENTS AND CONNECTABLE SYSTEM FOR CARRYING OUT THE METHOD

(71) Applicant: HELLA GmbH & Co. KGaA, Lippstadt (DE)

(72) Inventor: Georg FIEGLER, Lippstadt (DE)

(73) Assignee: HELLA GmbH & Co. KGaA, Lippstadt (DE)

(21) Appl. No.: 16/587,972

(22) Filed: Sep. 30, 2019

Related U.S. Application Data
(63) Continuation of application No. PCT/EP2018/057424, filed on Mar. 23, 2018.

(30) Foreign Application Priority Data
Mar. 28, 2017 (DE) 10 2017 106 622.5

(51) Int. Cl. B29C 65/78; B29C 65/00; B29C 65/16

(52) U.S. Cl. CPC B29C 65/7805; B29C 65/16; B29C 66/5414

(57) ABSTRACT

A connection method and a connectable system to enable the connection of three components with simpler means. To this end, the components are positioned in such a way that connection surfaces of the first and second component and engaging elements of the first or second component and the third component face each other; and the first component is bonded to the second component by means of the connection surfaces, and the first or second component is positively connected to the third component by means of the engaging elements during the movement of the components in relation to each other along the common joining axis, the third component being fixed parallel and transversely to the joining axis after the connection by means of the first and the second component.

This nonprovisional application is a continuation of International Application No. PCT/EP2018/057424, which was filed on Mar. 23, 2018, and which claims priority to German Patent Application No. 10 2017 106 622.5, which was filed in Germany on Mar. 28, 2017, and which are both herein incorporated by reference.

### BACKGROUND OF THE INVENTION

### Field of the Invention

The present invention relates to a method for connecting three components, and to a connectable system for carrying out a method.

### Description of the Background Art

Methods for connecting three components and connectable systems for carrying out such a method are already known from the prior art in numerous embodiments.

For example, a method is known from DE 10 2005 000 160 B4, which corresponds to U.S. Pat. No. 8,759,710, for positive locking connection of two components in which a first and a second component to be connected in a positive locking way are positioned relative to one another and the first component is bonded to a third component by laser transmission welding, wherein material from plastically deformable areas of the first component is displaced by a feed motion of the third component relative to the first component during the welding process in such a manner that the displaced material creates a positive locking connection between the first and the second component.

### SUMMARY OF THE INVENTION

It is therefore an object of the present invention to enable a connection of three components with simpler means.

An important advantage of the invention resides, in particular, in that the connection of three components is simplified from a production standpoint. For example, in the invention a laser transmission welding of the second component for producing a positive locking connection with the third component is omitted. Consequently, an additional laser transmission welding step is not necessary. In addition, the three components that can be connected by means of the invention are freely selectable within broader limits by type, material, dimensioning, and arrangement relative to one another. The invention is especially advantageous, for example, in cases when it is not possible to pass the second component through the third component.

Fundamentally, integral connection is freely selectable by the person skilled in the art from a multiplicity of integral connection technologies suited to the relevant individual case. Integral connection is advantageously implemented as welding, in particular as laser welding. Welding makes possible connections that are sealed and are durable for a long service life. Moreover, welding methods can be automated well. Laser welding in particular is advantageous because it is contactless and is also suited for more complex geometries of the components that are to be connected. Furthermore, laser welding ensures that there is only minor thermal distortion as compared with other welding methods.

An especially advantageous improvement of the method according to the invention provides that the mutually corresponding positive locking elements are implemented as at least one crush rib element and a receptacle corresponding to the crush rib element, and the positive locking connection is accomplished by a shearing off of the crush rib element. Crush rib connections can be produced in a structurally simple manner and have an intimate connection between the components to be connected. Furthermore, a crush rib connection permits greater component tolerances.

The same applies to an especially advantageous improvement of the connectable system according to the invention, according to which the mutually corresponding positive locking elements are implemented as at least one crush rib element and a receptacle corresponding to the crush rib element.

Another advantageous improvement of the connectable system according to the invention provides that the first component and/or the second component have/has at least one first projection, wherein the free end of the first projection is implemented as one of the mating surfaces. By means of the first projection, the mating surface formed thereon can be easily matched to the requirements of the integral connection, namely independently of the remainder of the first and/or second component. This is especially advantageous when the mating surfaces require a higher quality surface treatment for the integral connection, for example.

Another advantageous improvement of the connectable system according to the invention provides that the first component or the second component has at least one second projection, wherein the free end of the second projection of the first component or of the second component is implemented as a positive locking element. In this way the positive locking connection can be implemented in a structurally simple manner.

An advantageous improvement that is an alternative to the aforementioned embodiment provides that the first component has at least one second projection, wherein the free end of the second projection of the first component is implemented as a positive locking element, and a third projection of the second component is located in the region of the third component that faces away from the second projection during positive locking connection of the first and third components and serves as a support for the third component, or that the second component has at least one second projection, wherein the free end of the second projection of the second component is implemented as a positive locking element, and a third projection of the first component is located in the region of the third component that faces away from the second projection during positive locking connection of the second and the third components and serves as a support for the third component. In this way, a defined contact of the components that are to be connected to one another in a positive locking manner, and thus good transmission of force during production of the positive locking connection, is achieved.

Another advantageous improvement of the connectable system according to the invention provides that the first component and/or the second component have/has at least one fourth projection, wherein the free end of the fourth projection is implemented as a stop and limits joining travel along the joining axis during connection of the connectable system. In this way, a limiting of the common joining travel for producing the integral connection and the positive locking connection is achieved with structurally simple means.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 an exemplary embodiment of a connectable system according to the invention in a cross-sectional side view,

FIG. 2 illustrates a detail of the exemplary embodiment in the region of the crush rib element in a bottom view,

FIG. 3 illustrates the exemplary embodiment in another cross-sectional side view,

FIG. 4 illustrates an exemplary embodiment of a connectable system according to the invention in a cross-sectional side view,

FIG. 5 illustrates the exemplary embodiment in another cross-sectional side view, and

FIG. 6 illustrates an overall view of the crush rib elements corresponding to the second exemplary embodiment.

### DETAILED DESCRIPTION

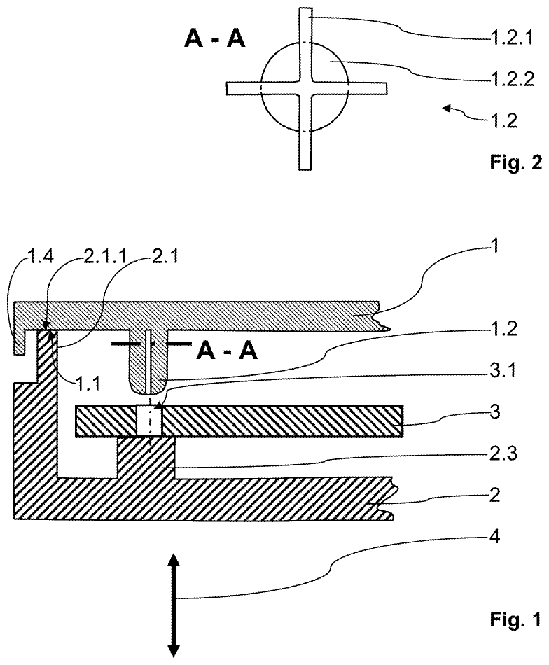

In FIG. 1, an exemplary embodiment of a connectable system according to the invention is shown. The connectable system includes three components to be connected to one another, namely a first component 1, a second component 2, and a third component 3. The first and the second component 1 and 2 are each implemented as a housing half made of plastic. The third component 3 is implemented as an electric printed circuit board that is accommodated in the housing formed by the first and the second components 1 and 2. In FIG. 1, the three components 1, 2, and 3 are not yet connected to one another. For the purpose of integral connection of the first and second components 1, 2, the second component 2 has a first projection 2.1 whose free end 2.1.1 is implemented as a mating surface. Corresponding to the mating surface 2.1.1 of the second component 2, the first component 1 has a mating surface 1.1. The two mating surfaces 1.1 and 2.1.1 are integrally connected to one another in a welding process implemented as a laser welding process in a manner to be explained below. For the purpose of positive locking connection of the first component 1 with the third component 3, the first component 1 has a second projection 1.2, which interacts with a receptacle 3.1 of the third component 3 to form a positive locking connection in the manner to be explained below. For this purpose, the second projection 1.2 is implemented as a crush rib element, which is explained in detail on the basis of FIG. 2. The receptacle 3.1 in the present exemplary embodiment is implemented as a through hole in the printed circuit board 3.

The crush rib element 1.2 is shown in FIG. 2 in a bottom view relative to the image plane of FIG. 1, and has four crush ribs 1.2.1 arranged in the shape of a cross in the bottom view, which ribs extend at right angles away from a core 1.2.2 of the crush rib element 1.2 in the bottom view. In order to facilitate an alignment of the crush rib element 1.2 with the through hole 3.1, and to reduce the force required to shear off the crush ribs 1.2.1, the crush ribs 1.2.1 are rounded at their free ends, as can be seen from FIG. 1. These curves consequently serve as lead-in bevels, and thus also permit relatively large component tolerances. A multiplicity of such crush rib elements and correspondingly designed and arranged receptacles can be provided for fixing the circuit board 3 in place.

So as to fix the third component 3 in place parallel and at right angles to a common joining axis for the integral connection and the positive locking connection by means of the first and second components 1, 2 after the connection of the connectable system, which is to say after the production of the integral connection of the first and second components 1,2 and after the production of the positive locking connection of the first and third components 1, 3, the second component 2 in the present exemplary embodiment has a third projection 2.3, which is located in the region of the third component 3 that faces away from the second projection 1.2 during positive locking connection of the first and third components 1, 3 and serves as a support for the third component 3. The joining axis is represented with a double-headed arrow 4 in FIG. 1.

Furthermore, the first component 1 has a fourth projection 1.4, wherein the free end of the fourth projection 1.4 is implemented as a stop and limits the common joining travel along the joining axis 4 for producing the integral connection and the positive locking connection during connection of the connectable system.

The method according to the invention for connecting three components is explained below in detail by way of example on the basis of the connectable system according to the first exemplary embodiment and on the basis of FIGS. 1 to 3.

First, the three components 1, 2, and 3 are positioned relative to one another in such a manner that the mutually corresponding mating surfaces 1.1 and 2.1.1 of the first and second components 1, 2 as well as the positive locking elements of mutually corresponding design, namely the crush rib element 1.2 and the through hole 3.1 of the first component 1 and of the third component 3, are located opposite one another. In this regard, see FIG. 1, in which the components 1, 2, and 3 that are to be connected to one another are shown in the end position following positioning for the subsequent connection of the components 1, 2, and 3.

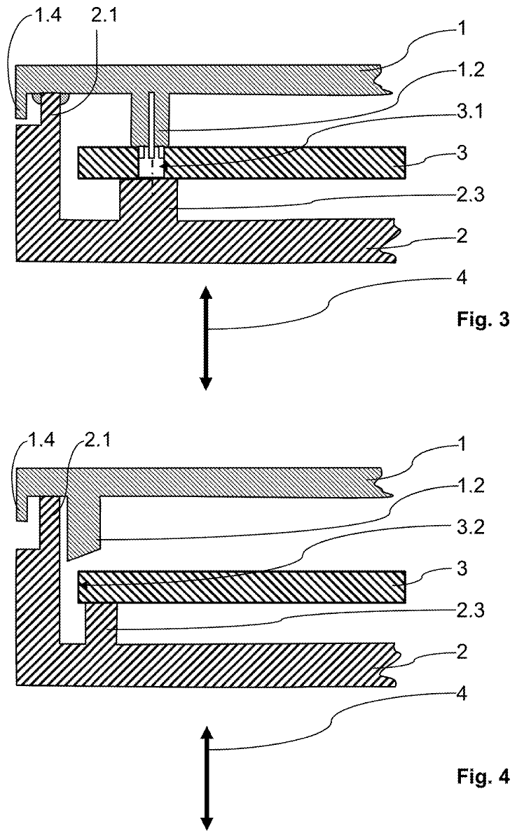

In a next step, the components 1, 2, and 3 are moved relative to one another along the common joining axis 4 in such a manner that the mating surfaces 1.1 and 2.1.1 and the positive locking elements, namely the crush rib element 1.2 and the through hole 3.1, are each moved toward one another by means of a joining force. For this purpose, the second component 2 is fixed in place by means of a holder, and the first component 1 is moved by means of a feed device toward the second component 2 and the third component 3 that is placed on the third projection 2.3 of the second component 2. In this regard, see FIG. 1 in conjunction with FIG. 3.

As is evident from FIG. 1, the mating surfaces 1.1 and 2.1.1 for the integral connection of components 1 and 2 are already resting against one another so the laser welding process by means of a laser welding device can begin in a manner known to the person skilled in the art. In this process, the two components 1 and 2 are melted in the region of the mating surfaces 1.1 and 2.1.1 so that the first component 1 can move further in the direction of the second and third components 2, 3.

As soon as the crush rib element 1.2 and the through hole 3.1 for the positive locking connection of the components 1 and 3 come into contact with one another, the positive locking connection of the components 1 and 3 begins in parallel with the integral connection of the components 1 and 2. In this process, the crush rib element 1.2 engages the boundary walls of the through hole 3.1 in such a manner that the crush ribs 1.2.1 of the crush rib element 1.2 are sheared off on account of the higher strength of the printed circuit board 3. For this purpose, the third component 3 rests on the third projection 2.3 that is designed as a support.

See also FIG. 3 in this regard, which shows an intermediate position of the connectable system during the integral connection and positive locking connection of the three components 1, 2, and 3. During the joining processes, which is to say the integral connection and positive locking connection, the first component 1 is moved further along the joining axis 4 in the direction of the second and third components 2, 3 as a result of the joining force. The joining distance traveled in this process does not end until the fourth projection 1.4 of the first component 1 rests against the second component 2. Because of the resultant increase in the joining force, the laser welding process is ended. The first component 1 is then bonded to the second component 2 at the mating surfaces 1.1 and 2.1.1 by means of the welded joint, and is connected in a positive locking manner to the third component 3 by means of the crush rib element 1.2 and the through hole 3.1. As a result of the integral and positive locking connections of the three components 1, 2, and 3, the third component 3 is fixed in place parallel and at right angles to the common joining axis 4 by means of the first and second components 1, 2.

In FIGS. 4 to 6, a second exemplary embodiment of a connectable system according to the invention is shown that is explained below only to the extent of the differences from the first exemplary embodiment. The same or equivalent components are labeled with the same reference symbols.

In FIG. 4, the second exemplary embodiment of a connectable system according to the invention is shown in a cross-sectional side view analogous to FIG. 1 for the first exemplary embodiment. In contrast to the first exemplary embodiment, the printed circuit board 3 has no through hole in which a crush rib element would engage. Instead, the second projection 1.2 of the first component 1, designed as a crush rib element, is arranged on the first component 1 opposite an edge region 3.2 of the printed circuit board 3. The crush rib element 1.2 of the second exemplary embodiment has only one crush rib 1.2.1 which, in a manner similar to the first exemplary embodiment, has a lead-in bevel on its free end that is visible in FIG. 4. The first component 1, with the crush rib element 1.2, engages a gap located between the second component 2 and the edge region 3.2 of the third component 3. Further details are analogous to the first exemplary embodiment.

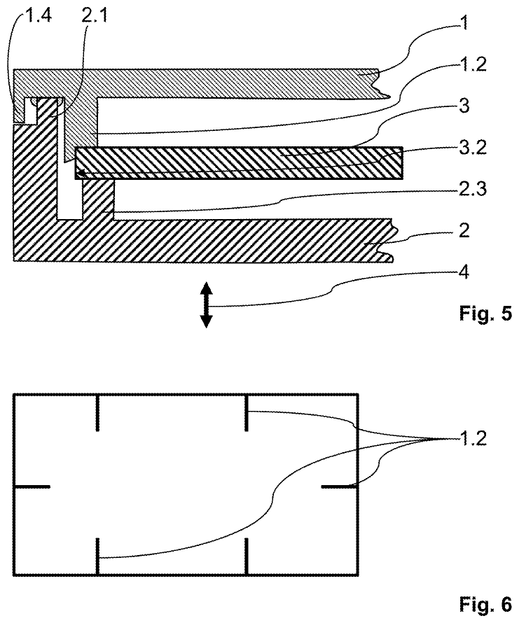

FIG. 5 shows the second exemplary embodiment in a representation comparable to FIG. 3 of the first exemplary embodiment, namely in an intermediate position of the connectable system during the integral connection and positive locking connection of the three components 1, 2, and 3. During the joining processes, which is to say the integral connection and positive locking connection, the first component 1 is moved further along the joining axis 4 in the direction of the second and third components 2, 3 as a result of the joining force. The joining distance traveled in this process does not end until the fourth projection 1.4 of the first component 1 rests against the second component 2. Because of the resultant increase in the joining force, the laser welding process is ended. The first component 1 is then bonded to the second component 2 at the mating surfaces 1.1 and 2.1.1 by means of the welded joint, and is connected in a positive locking manner to the third component 3 by means of the crush rib element 1.2 and the edge region 3.2. As a result of the integral and positive locking connection of the three components 1, 2, and 3 according to the second exemplary embodiment, the third component 3 is fixed in place parallel and at right angles to the common joining axis 4 by means of the first and second components 1, 2.

Shown in FIG. 6 is a purely schematic overall view of the crush rib elements 1.2 in a bottom view with respect to the image plane of FIG. 5, wherein the printed circuit board 3 is located in the center of FIG. 6 formed by the crush rib elements 1.2. It is evident therefrom that the crush rib elements 1.2, and thus the individual crush ribs 1.2.1, of the second exemplary embodiment are distributed along the entire edge region 3.2 of the printed circuit board 3. In this case, the structure of the individual crush rib elements 1.2, and thus of the individual crush ribs 1.2.1, is identical; the same applies to the positive locking connection, which is accomplished analogously to that of the first exemplary embodiment.

The invention is not limited to the present exemplary embodiments. For example, other integral and positive locking connections are also possible. The individual projections, mating surfaces, and positive locking elements are also freely selectable within broad suitable limits by type, material, dimensioning, and arrangement depending on the requirements of the individual case. For example, it is also possible that the second component has at least one second projection, wherein the free end of the second projection of the second component is designed as a positive locking element, and a third projection of the first component is located in the region of the third component that faces away from the second projection during positive locking connection of the second and third components and serves as a support for the third component.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for connecting three components, the method comprising:
positioning the three components such that mutually corresponding mating surfaces of the first and second components as well as positive locking elements of mutually corresponding design of the first or second component and of the third component are located opposite one another;
moving the three components relative to one another along a common joining axis such that the relevant mating surfaces and the relevant positive locking elements are moved toward one another; and
integrally connecting the first and second components via the mating surfaces and positive locking connection of the first or second component to the third component via the positive locking elements during the movement of the components relative to one another along the common joining axis,
wherein the third component is fixed in place parallel and at right angles to the joining axis via the first and second components after the integral and positive locking connection.

2. The method according to claim 1, wherein the integral connection is implemented as welding or laser welding.

3. The method according to claim 1, wherein the mutually corresponding positive locking elements are implemented as at least one crush rib element and/or a receptacle corresponding to the crush rib element, and wherein the positive locking connection is accomplished by a shearing off of the crush rib element.

4. A connectable system for carrying out the method according to claim 1, the system comprising:
three components to be connected to one another, wherein a first and a second component have mutually corresponding mating surfaces for integral connection, and the first or second component and a third component have mutually corresponding positive locking elements for positive locking connection, wherein the mating surfaces are designed and oriented relative to one another such that the first and the second components are relatively movable toward one another along a common joining axis during their integral connection,
wherein the positive locking elements are designed and oriented relative to one another such that the first or second component and the third component are relatively movable toward one another along the common joining axis during their positive locking connection, and the third component is fixed in place parallel and at right angles to the joining axis via the first and second components after the integral and positive locking connection.

5. The connectable system according to claim 4, wherein the mutually corresponding positive locking elements are at least one crush rib element and/or a receptacle corresponding to the crush rib element.

6. The connectable system according to claim 4, wherein the first component and/or the second component have at least one first projection, and wherein the free end of the first projection is implemented as one of the mating surfaces.

7. The connectable system according to claim 4, wherein the first component or the second component has at least one second projection, and wherein the free end of the second projection of the first or second component is a positive locking element.

8. The connectable system according to claim 4, wherein the first component has at least one second projection, wherein a free end of the second projection of the first component is implemented as a positive locking element, and a third projection) of the second component is located in the region of the third component that faces away from the second projection during positive locking connection of the first and the third components and serves as a support for the third component, or wherein the second component has at least one second projection, and wherein the free end of the second projection of the second component is a positive locking element, and a third projection of the first component is located in a region of the third component that faces away from the second projection during positive locking connection of the second and third components and serves as a support for the third component.

9. The connectable system according to claim 4, wherein the first component and/or the second component have at least one fourth projection, wherein a free end of the fourth projection is implemented as a stop and limits joining travel along the joining axis during connection of the connectable system.
